(19) United States
(12) Patent Application Publication
(10) Pub. No.: US 2018/0213735 A1
(43) Pub. Date: Aug. 2, 2018

(54) HORTICULTURAL LIGHTING SYSTEMS, SENSOR MODULES, AND CONTROL SYSTEMS

(71) Applicant: Precision AgriTech Inc., Vernon, CA (US)

(72) Inventors: Matthew Vail, Vernon, CA (US); Eric Ellestad, Vernon, CA (US)

(21) Appl. No.: 15/887,919

(22) Filed: Feb. 2, 2018

Related U.S. Application Data
(63) Continuation of application No. PCT/US2016/045432, filed on Aug. 3, 2016.
(60) Provisional application No. 62/200,584, filed on Aug. 3, 2015.
(60) Provisional application No. 62/205,712, filed on Aug. 15, 2015.
(60) Provisional application No. 62/205,715, filed on Aug. 15, 2015.

(51) Int. Cl. A01G 31/06; A01G 7/04

(52) U.S. Cl. CPC A01G 31/06; A01G 9/26; A01G 7/045

(57) ABSTRACT

A high-density horticultural system having a lighting system is provided. The horticultural system comprises a lower shelving component that is attached to a first bracket within a vertical racking system. The horticultural system also comprises an upper shelving component. The upper shelving component is attached to a second bracket within the vertical racking system, wherein the second bracket is vertically displaced 11 inches from the first bracket. Additionally, the horticultural system comprises a lighting system that extends down from the upper shelving component. The lighting system component has a lighting fixture that extends from the top portion of the lighting system, a bottom cover that is at the bottom portion of the lighting portion, and a duct between the lighting fixture and the bottom cover.

### CROSS-REFERENCE TO RELATED APPLICATIONS

This application claims the benefit of U.S. Provisional Patent Application Ser. No. 62/205,715 entitled “Integrated Horticultural Lighting System,” filed Aug. 15, 2015; U.S. Provisional Patent Application Ser. No. 62/200,584 entitled “Sensor Module,” filed Aug. 3, 2015; U.S. Provisional Patent Application Ser. No. 62/205,712 entitled “Horticultural Control System,” filed Aug. 15, 2015; the disclosure of each application is hereby incorporated by reference in its entirety.

### BACKGROUND

The global food system faces severe challenges from environmental risks, especially drought, and inefficient and wasteful supply-chains that result in significant price and supply volatility of perishable crops. In addition, the global food system is strained by a growing population and increased demand for healthy, responsibly grown food. Furthermore, conventional food production places an enormous burden on the environment oftentimes using more than 80% of available fresh water, a huge amount of electricity, an enormous supply of labor, and unprecedented volumes of chemicals. The result is an incredible burden on the environment and millions of Americans who lack access to fresh, healthy, and affordable produce.

Conventional agriculture is centered on vast commercial farms encompassing hundreds of acres planted almost exclusively in monocultures. These conventional farms rely on thousands of tons of nitrate fertilizers, pesticides, and herbicides in order to support monocultures that rapidly deplete soil nutrients and encourage crop-specific pathogens. Continued used of synthetic fertilizers leads to long term depletion of micro and macro nutrients in the soil in addition to destruction of the microbial community that is an important aspect of soil health; this results in detrimental environmental effects as well as food that is less nutrient dense, less healthy, and less flavorful. Conventional agriculture is unsustainable and irresponsible and does not even produce the nutritious food needed to nourish the world's population.

So-called “organic” agriculture has been touted as the solution to the concerns associated with conventional agriculture. Organic agriculture is a return to “traditional” practices of composting, polycultures, and local eating. However, organic agriculture has at least as many issues as conventional farming. Organic agriculture typically yields 20-25% less per acre than conventional agriculture, meaning that more land is required, and given that over a third of the planet is already used for agriculture, it is beneficial to maximize yield per acre. Furthermore, organic agriculture requires even more water than the conventional agriculture that it claims to improve up and the food has little or no additional nutritional value. Organic agriculture fails to improve upon many of the issues with the current food supply system.

Urban agriculture is another trend in recent years that claims to solve the major concerns surround the food supply, however urban agriculture is not commercially viable. Limited growing space, lack of inexpensive labor, and high production costs prohibit urban agriculture from providing a significant amount of the food supply.

Greenhouse growing has increased in recent years and shows some promise at alleviating some of the issues that the current supply chain faces, but it falls short in many categories. Greenhouse crops can be grown in more climates and for more of the year and they do reduce overall water usage, but greenhouses are extremely expensive and are only commercially viable in certain geographies. Furthermore, greenhouse grown produce is often less nutritious and less flavorful than even conventional produce, and greenhouses require expert management with significant experience and very specific knowledge to operate successfully. The portion of produce that is grown in greenhouses is likely to increase, but greenhouses do not address the key issues in the food supply chain.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings, equations and description are to be regarded as illustrative in nature, and not as restrictive.

### SUMMARY

Horticultural lighting systems, sensor modules, and control systems are provided. These systems and modules may be used in controlled environmental agriculture systems. Controlled environmental agriculture systems may be used to grow plants and crops. In some examples, the controlled environmental agriculture systems may be used to grow plants and crops in indoor farms. Within the controlled environmental agriculture systems, crops may be exposed to light, airflow, and nutrients so as to allow the crops to grow. In particular, horticultural lighting systems, sensor modules, and control systems as discussed herein may be used to improve growing conditions for crops and plants in controlled environmental agriculture systems.

The present disclosure provides horticultural lighting systems. In examples, a horticultural lighting system comprises a lower shelving component, such as a lower shelf, and an upper shelving component, such as an upper shelf. The lower shelf may support a growing plant and/or crop. The upper shelf may have a lighting unit attached to the upper shelf. In particular, the upper shelf may have a lighting unit hanging from the upper shelf. In some examples, the lighting unit may be integrated into the upper shelf. The upper shelf and lower shelf may be part of a racking system within the controlled environmental agriculture. In particular, the controlled environmental agriculture may have brackets attached to one or more walls. The upper shelf and lower shelf may be attached to the brackets to form a racking system. The racking system may be formed as a high-density racking system having a plurality of vertical shelves within the housing, wherein a vertical distance between two adjacent vertical shelves is not more than 11 inches. In some examples, a vertical distance between two adjacent vertical levels is not more than 4 inches, 5 inches, 6 inches, 7 inches, 8 inches, 9 inches, 10 inches, 11 inches, 12 inches, 15 inches, or 18 inches. In some examples, a vertical distance between two adjacent vertical levels is more than 18 inches.

The lighting unit that hangs from the upper shelf may comprise a lighting fixture that is attached to a top portion of the lighting unit so as to allow open space between the top portion of the lighting unit and a bottom portion of the lighting unit. The bottom portion of the lighting unit may comprise a cover. In examples, the cover may be a plastic. In some examples, the cover may be plexiglass. Additionally, the space between the top portion of the lighting portion and the bottom portion of the lighting unit may comprise a duct. Air may flow within the lighting unit between the lighting fixture and the cover. The cover may also have holes through which air may flow to plants beneath the lighting unit. This example of an airflow system that provides air to plants may be beneficial to plants grown in compact conditions, such as high-density racking systems. By integrating airflow with a lighting source, plants may receive at least two benefits to plant growth (e.g., light and airflow) from one lighting system. Additional examples of lighting units and lighting systems are discussed further below.

In one aspect, a high-density horticultural system having a lighting system is provided. The horticultural system comprises a lower shelving component that is attached to a first bracket within a vertical racking system; an upper shelving component, wherein the upper shelving component is attached to a second bracket within the vertical racking system, wherein the second bracket is vertically displaced 11 inches from the first bracket; and a lighting system that extends down from the upper shelving component, wherein the lighting system component has a lighting fixture that extends from the top portion of the lighting system, a bottom cover that is at the bottom portion of the lighting portion, and a duct between the lighting fixture and the bottom cover.

In another aspect, a high-density horticultural system having a lighting system is provided. The horticultural system comprises a lower shelving component that is attached to a first bracket within a vertical racking system; an upper shelving component, wherein the upper shelving component is attached to a second bracket within the vertical racking system, wherein the second bracket is vertically displaced 11 inches from the first bracket; and a lighting system that extends down from the upper shelving component, wherein the lighting system component has a lighting fixture that extends from the top portion of the lighting system, a bottom cover that is at the bottom portion of the lighting portion, wherein the bottom cover has a plurality of holes that are configured to direct airflow to plants beneath the lighting system.

In a further aspect, a high-density horticultural system having a lighting system is provided. The horticultural system comprises a lower shelving component that is attached to a first bracket within a vertical racking system; an upper shelving component, wherein the upper shelving component is attached to a second bracket within the vertical racking system, wherein the second bracket is vertically displaced 11 inches from the first bracket; and a lighting system that extends down from the upper shelving component, wherein the lighting system component has a lighting fixture that extends from the top portion of the lighting system, a bottom cover that is at the bottom portion of the lighting portion, wherein the lighting system has airflow passages passing through the lighting system so as to provide airflow to plants beneath the lighting system.

In an additional aspect, a high-density horticultural system having a lighting system is provided. The horticultural system comprises a lower shelving component that is attached to a first bracket within a vertical racking system; an upper shelving component, wherein the upper shelving component is attached to a second bracket within the vertical racking system, wherein the second bracket is vertically displaced 11 inches from the first bracket; and a lighting system that extends down from the upper shelving component, wherein the lighting system in the racking system is adjacent to at least one airflow passage attached to the racking system so as to provide airflow to plants beneath the lighting system.

The present disclosure also provides horticultural sensor modules. Sensor modules may be used to monitor growing conditions of plants or crops growing in a controlled environmental agriculture system. In particular, sensor modules may be used to measure environmental characteristics such as temperature and humidity. Additionally, sensor modules may use ultrasound to determine a distance between the sensor and one or more leaves beneath the sensor. The use of ultrasound may be beneficial in that ultrasound may determine a distinct distance between two leaves and the location of the ultrasound sensor. In contrast, an imaging system such as a camera may not be able to distinguish leaves in a two-dimensional image of multiple leaves.

Sensor modules may also be designed to have a short height. Sensors having a shortened height, or low profile, may be advantageous in systems that are ultra-compact plant growing systems. In examples, a sensor component may be attached direct to a circuit board so as to make a resulting sensor module approximately 1 inch tall. In examples, a sensor module may be less than 1 inch tall; may be 1.1 inches tall; may be 1.2 inches tall; may be 1.3 inches tall; may be 1.4 inches tall; may be 1.5 inches tall; may be 1.6 inches tall; may be 1.7 inches tall; may be 1.8 inches tall; may be 1.9 inches tall; may be 2 inches tall; may be 2.1 inches tall; may be 2.2 inches tall; may be 2.3 inches tall; may be 2.4 inches tall; may be 2.5 inches tall; may be 2.6 inches tall; or may be more than 2.6 inches tall. Additional examples of sensor modules are discussed further below.

In one aspect, a high-density horticultural system having a sensor module is provided. The horticultural system comprises a lower shelving component that is attached to a first bracket within a vertical racking system; an upper shelving component, wherein the upper shelving component is attached to a second bracket within the vertical racking system, wherein the second bracket is vertically displaced 11 inches from the first bracket; and a sensor module that extends down from the upper shelving component, wherein the sensor module comprises at least an ultrasound sensor and at least an imaging sensor.

In another aspect, a high-density horticultural system having a sensor module is provided. The horticultural system comprises a lower shelving component that is attached to a first bracket within a vertical racking system; an upper shelving component, wherein the upper shelving component is attached to a second bracket within the vertical racking system, wherein the second bracket is vertically displaced 11 inches from the first bracket; and a sensor module that extends down from the upper shelving component, wherein the height of the sensor module extending down from the upper shelving component is less than two inches.

In a further aspect, a high-density horticultural system having a sensor module is provided. The horticultural system comprises a plurality of lower shelving components that are each attached to a bracket within a vertical racking system; a plurality of upper shelving components, wherein each upper shelving component of the plurality of upper shelving components are attached to a bracket within the vertical racking system, wherein each bracket that is attached to a upper shelving component of the plurality of upper shelving components is vertically displaced 11 inches from a bracket that is attached to a corresponding lower shelving unit of the plurality of lower shelving components; and a sensor module that extends down from the upper shelving component, wherein sensor module is translatable in at least one directions with respect to the vertical racking system.

Additionally, the present disclosure provides horticultural control systems. In particular, control systems may be used to monitor and regulate plant growing systems, such as CEA's. In some examples, the control systems may monitor and/or regulate indoor farm modules. A control system may be used to monitor and/or regulate one or more growing characteristics of plants or crops within indoor farm modules. In examples, a control system may monitor and/or regulate a plurality of indoor farm modules. In particular, the control system may monitor multiple facilities each having containers that hold an indoor farm module. The control system may have a user interface that allows the control system to monitor and/or regulate each of the facilities and/or indoor farm modules using the same user interface. Additionally, the user may regulate sub-units of an indoor farm module. For example, a user may regulate a particular shelving level within an indoor farm module. In additional examples, the user may regulate a portion of a particular shelving level within the indoor farm module.

In another aspect, a method for regulating a horticultural high-density growing system is provided. The method comprises monitoring growth of a given plant in the horticultural high-density growing system; receiving an indication of leaf density within the high-density growing system; associating the received leaf density with a stage of growth of the given plant; and modifying growing conditions of the given plant based on the stage of growth of the given plant.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings, equations and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 illustrates a top view of a modular indoor farm, in accordance with embodiments of the invention;

FIG. 2 illustrates a side view of a high-density racking system, in accordance with embodiments;

FIG. 3 illustrates an end view of a high-density racking system, in accordance with embodiments;

FIG. 4 illustrates a perspective end view of a high-density racking system, in accordance with embodiments;

FIG. 5 illustrates an integrated airflow management lighting system, in accordance with embodiments.

FIG. 6 illustrates a front, internal view of a modular indoor farm, in accordance with embodiments.

FIG. 7 illustrates a side, internal view of a modular indoor farm, in accordance with embodiments.

FIG. 8 illustrates an end view of a horticultural lighting system including an integrated airflow system, in accordance with embodiments.

FIG. 9 illustrates a front view of an integrated horticultural lighting system having an integrated airflow system.

FIG. 10 illustrates a side view of a lighting system having a first airflow system, in accordance with embodiments.

FIG. 11 illustrates an end view of a lighting system having a first airflow system, in accordance with embodiments.

FIG. 12 illustrates a side view of a lighting system having a second airflow system, in accordance with embodiments.

FIG. 13 illustrates an end view of a lighting system having a second airflow system, in accordance with embodiments.

FIG. 14 illustrates a side view of a lighting system having a third airflow system, in accordance with embodiments.

FIG. 15 illustrates a top view of a lighting system having a third airflow system, in accordance with embodiments.

FIG. 16 illustrates a side view of daisy chaining lighting fixtures in a horticultural lighting system, in accordance with embodiments.

FIG. 17 illustrates a light fixture having diodes that are laid out in an interlocking formation, in accordance with embodiments.

FIG. 18 illustrates inter-digitate hermaphroditic connectors in an integrated lighting system, in accordance with embodiments.

FIG. 19 illustrates an overhead view of a diode layout row of an integrated lighting system, in accordance with embodiments.

FIG. 20 illustrates a side view of a diode layout row of an integrated lighting system, in accordance with embodiments.

FIG. 21 illustrates on overview of a series of diode layout rows of an integrated lighting system, in accordance with embodiments.

FIG. 22 illustrates a side view of a light fixture having ten LED boards and two wire harnesses, in accordance with embodiments.

FIG. 23 illustrates a view of two wire harnesses, in accordance with embodiments.

FIG. 24 illustrates a perspective view of a sensor module, in accordance with embodiments.

FIG. 25 illustrates a perspective view of a sensor module within a single growing unit, in accordance with embodiments.

FIG. 26 illustrates a perspective view of a rotary actuator attached to a sensor housing, in accordance with embodiments.

FIG. 27 illustrates a charging dock in accordance with embodiments.

FIG. 28 illustrates an overview of a control system architecture, in accordance with embodiments.

FIG. 29 illustrates a process of data transfer, in accordance with embodiments.

FIG. 30 shows a computer control system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

### Controlled Agriculture Environment Systems

Examples of controlled agriculture environment systems that may be used with horticultural lighting systems, sensor modules, and control systems and described herein. An example of an apparatus for high density crop production may include a plurality of walls, a floor, and a ceiling, collectively referred to as a module. The module may be an indoor farm module. A module may be any form of enclosure, including a box, a cube, a sphere, a pyramidal shape, or other three dimensional geometries not consisting of walls, floor, and/or ceiling.

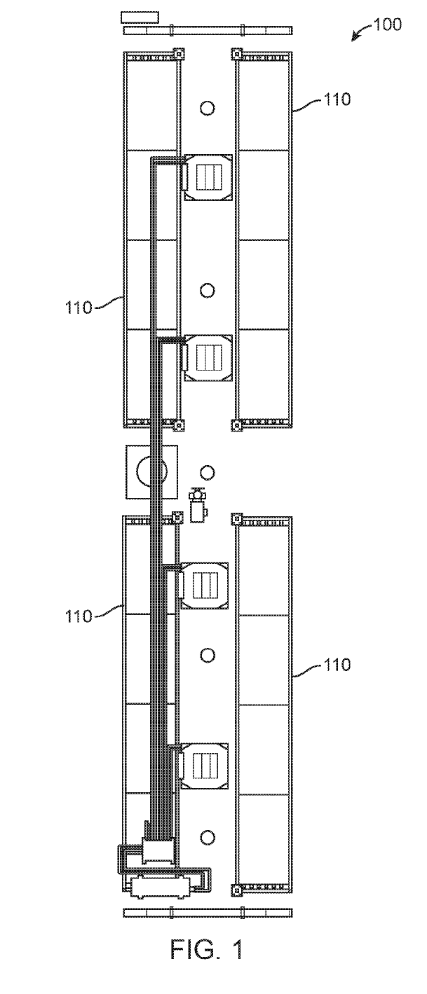

Examples of indoor farm modules are provided in FIGS. 1-4. In particular, FIG. 1 illustrates a top view of a modular indoor farm 100, in accordance with embodiments of the invention. As seen in FIG. 1, modular indoor farm 100 includes a plurality of high-density racking systems 110. Each high-density racking system may include an integrated airflow management and lighting system, which will be discussed further in additional figures.

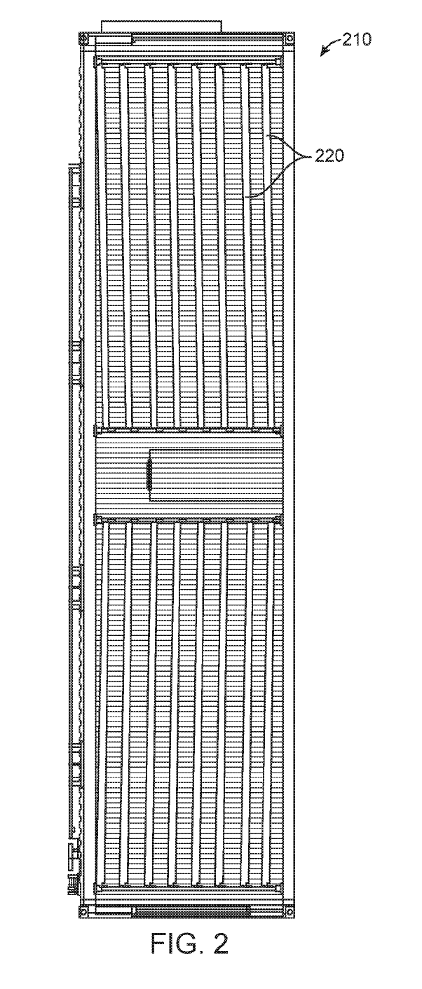

FIG. 2 illustrates a side view of a high-density racking system 210, in accordance with embodiments of the invention. As seen in FIG. 2, high-density racking system 210 includes a plurality of levels 220. In some examples, levels 220 of the high-density lighting system 210 may be arranged vertically. In some examples, levels 220 may be arranged horizontally. In some examples, levels 220 may be arranged vertically and horizontally.

High-density racking system 210 may include an integrated airflow management lighting system (not shown). In some examples, the use of an integrated airflow management system may be used to enable growing plants in a high-density racking system having many vertical levels per vertical foot. In examples, a high-density racking system may have 1, 2, 3, 4, 5, 6, or more than 6 vertical levels per vertical foot. Having many vertical levels per vertical foot within a high-density racking system may increase the production density of a modular indoor farm having a high-density racking system. Additionally, an integrated airflow management within a modular indoor farm may be used to cool lights within the high-density racking system as it provides airflow to crops. As such, an integrated airflow management system may improve the operating efficiency of a lighting system within the modular indoor farm and/or the modular indoor farm overall.

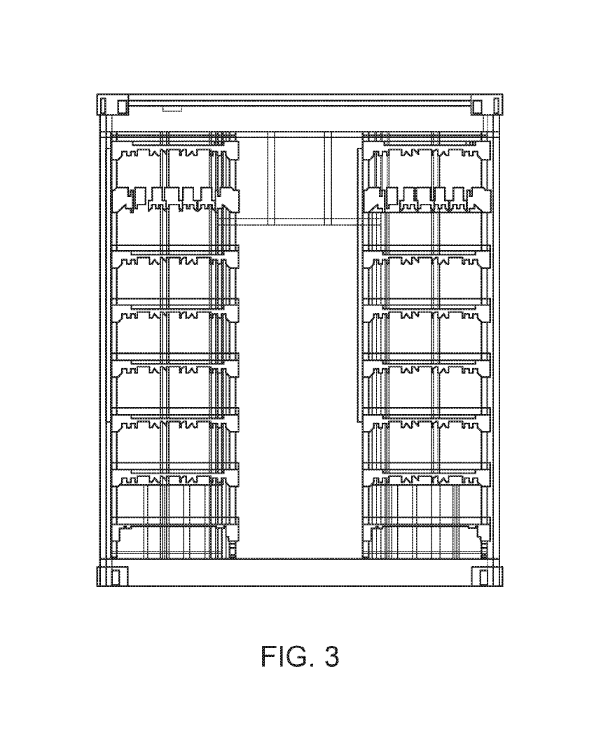

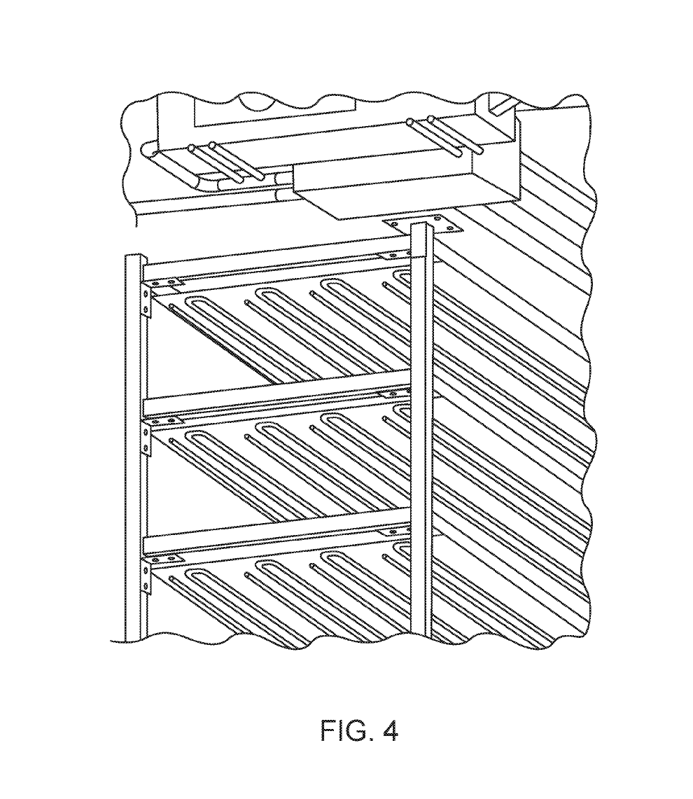

FIG. 3 illustrates an end view of a high-density racking system, in accordance with embodiments. Additionally, FIG. 4 illustrates a perspective end view of a high-density racking system, in accordance with embodiments.

One or more components of the module may be insulated using 4″ thick polyethylene foam. In examples, one or more of the components of the module may be insulated using a variety of other materials and volumes. In some examples, one or more of the components of the module may not be insulated at all. In order to control the growing environment that the plants experience, one or more environmental aspects of the module may be controlled. In some examples, temperature and humidity may be controlled within precise ranges. The control of environmental aspects of a module may be very challenging for greenhouse growers as well as growers in warehouses where insulation and isolation from the environment can be spotty at best. The insulation included in the walls of an indoor farm module, such as modules discussed herein, may allow the growing environment to be almost entirely isolated from the elements outside the module, such as weather (e.g., wind, temperature, rain). In some examples, the modular farming unit insulation may have an R-value of 5 or greater. In some examples, materials with R-values greater than 7 may be preferred for use in a farming unit insulation.

Light use efficiency and so-called edge cases may each also pose a challenge to growing plants or crops within indoor vertical farms. Light use efficiency may be defined as the percentage of the artificial light that is incident on the plant canopy. In some examples, the larger the percentage of light that falls on the canopy, the overall lighting system may become more efficient. As the overall lighting system becomes more efficient, the cost to grow produce may be lowered. In some examples, edge cases may occur that include undersized or poorly formed plants that result from lower light intensities on the edges of vertical levels. In order to mitigate these challenges, the components of a module may be highly reflective on one or more of their internal surfaces. For example, one or more of the components of the module may be coated in a Mylar sheet that reflects 95% or more of the total light. Additionally, one or more of the components of the module may be made to be reflective in a variety of other ways, including by being made out of food grade aluminum, by being painted with a high reflectivity white, and/or by using nano-material to coat the surfaces with fiber optic like materials. Furthermore, the reflective coating may scatter light in a way that results in indirect light on and under the plant canopy. This may increase the photosynthetic efficiency of the crop by enabling sub-canopy leaf tissue to absorb and use indirect light.

Indoor farming modules may also include a system for controlling the intensity of white, blue, and red light on each level independently via a pulse width modulating control puck. This example of a control method may allow precise control over white, blue, and red intensities on each level to within a percentage. Precise control over light spectrum may enable the grower to optimize the photosynthetic efficiency of each crop. Control may also be achieved by a number of other methods including I2C or serial communication, 0-10V, 0-20 mA, or any other analog protocol or any other digital communication method. Each different type of crop that performs optimally under different red, blue, green conditions, and a single crop may perform differently across different stages. Furthermore, plants may be exceedingly sensitive to different light spectrums, and spectrum design can dramatically affect the morphology of the crop. As such, precise control over light spectrum may enable the grower to optimize lighting not just to increase yield but also to drive other crop characteristics such as leaf shape, density, nutrient content, and/or antioxidant levels, etc.

Indoor framing modules, as discussed herein, may contain a plurality of mechanical racking systems coupled to one or more of the floor, the ceiling, the walls, and/or a combination of the former within a controlled environment agriculture system. In some examples, the indoor farming modules as discussed herein may contain one or more mechanical racking systems that are not coupled at all to an indoor farming module. In some examples, the indoor farming modules may be freestanding. Indoor farming modules may further contain a plurality of horizontal racks, each individually referred to as a level.

Each level of an indoor farming module may contain an integrated air flow management lighting system. An integrated air flow management lighting system may consist of a lighting apparatus. Additionally, a lighting apparatus may comprise one or more fluorescent lights, incandescent bulbs, halogen bulbs, high pressure sodium lamps, plasma lamps, LEDs, or another photon generating devices. The integrated air flow management lighting system may also include an air flow generator such as a duct fan, in-line fan, centrifugal fan, regenerative blower, or another mechanism for generating air flow. Additionally, an integrated air flow management lighting system may include an air duct that can be composed of transparent and/or reflective components. An air duct may also contain variable area vents that may allow air to flow through to the crop canopy at variable rates and volumes. Additionally, air vents may also be used to create, by being increased or decreased in size, turbulent, mixed, and/or laminar airflow. A particular airflow characteristic, such as turbulent, mixed, and/or laminar airflow, may be chosen by an operator of an integrated air flow management lighting system. In particular, an operator of the integrated air flow management lighting system may affect airflow within the integrated air flow management lighting system by modifying air vents within the system.

Each level within a high-density vertical racking system may contain a system of plastic pipes known collectively as the irrigation system. The irrigation system may be used for delivering water, nutrients, dissolved oxygen, and any other of a variety of soluble requirements including beneficial bacteria, sterilizing agents, oxidizing agents, signaling molecules and more as well as any other beneficial chemicals or inputs via the open air within to the plants. The irrigation system may be used to provide inputs to the root system of the crops. Additionally, indoor farming modules may include a system of plumbing that may be used for at least one of pumping water to each level of crops, recapturing that water, sterilizing and dosing that water, and recirculating it back to each level of crops, collectively referred to as the recirculating system. One or more levels may be supplied via a 24V ball valve. In examples, one or more levels may be drained using an additional 24V ball valve. In examples, a system, such as the system described, may allow for the precise control of at least one of: inflow rate, inflow time, rest time, outflow rate, outflow time, and/or frequency of watering. Precise control over irrigation in a hydroponic system may be used to obtain optimal crop growth. In examples, this system may allow each level to be irrigated independently. This may enable multiple crops to exist in the system and receive precise targeted irrigation based on their stage of growth, crop type, desired traits, and/or other factors.

A specific challenge of some modular vertical farms is the desire to have multiple crops at very different stages in a single system. For example, a single system may have a youngest crop; a middle crop; and an oldest crop. The youngest crop maybe between 0 and 15 days old, and may be referred to as “propagation.” The middle crop may be between 15 and 30 days old, and may be referred to as “seedling.” Additionally, the oldest crop may be between 30 and 45 days old, and may be referred to as “finishing.” A challenge of having a single system for crops in multiple stages of growth is that different crop stages may require different, or very different, watering schedules, volumes, intensities, etc. as well as very different fertilizers. Given this, the ability to control the irrigation at each level of an indoor farming module, and/or to be able to water from different reservoirs, may enable the grower to have multiple crops in a single indoor farming module while still optimizing the irrigation for each stage. Not having this control may result in dramatically overwatering the younger crops in order to provide the finishing crop with enough water, effectively reducing overall yields and increasing costs. In examples, a system as described herein may be designed with a feed on one side of the tray and a drain on the opposite side, each with an automated valve. The valves can be 24V ball valves, as in the specified system, or another style of valve. In additional examples, additional ways of controlling voltage may be provided.

In examples, the water in a recirculating system may be sterilized using a customized ozone system that has been developed for use in low volume settings in combination with a UV sterilizer. Sterilization may also be achieved by a plurality of other methods, such as autoclaving, boiling, bleaching, introduction of a high concentration of an oxidizing agents (such as paracetic acid or hydrogen peroxide), and/or intense mechanical disruption. In some examples, the ozone sterilization system may be designed with an intermediate stage pressurized tank that creates a supraoxygenated solution (>20 PPM) that is then delivered to the recirculating system. This supraoxygenation may result in better crop yields and may also be achieved by a cooled intermediate stage.

In examples, indoor farming modules may include a system for monitoring and controlling the ambient environment including the temperature, relative humidity, and/or partial pressure of CO₂. Environmental control may be one of the most important aspects of an indoor growing system. Precise control of temperature and humidity may be important, or even essential, to optimal growing. An apparatus as describe herein may accomplishes this using a commercial heat pump with refrigerant, condenser, evaporative coil, industrial blower, electric heater, and/or fans. This system may allow for efficient cooling and dehumidifying of the system. A module may also include custom controls that may allow refrigerant to be pumped through the evaporative coil at a variable rate. This may increase the dehumidifying range and reduce or eliminate the need for re-heat dehumidifying, thereby increasing overall efficiency and/or reducing cost.

Additionally, indoor farming modules may include a system for monitoring and controlling the water quality including the water temperature, pH, EC, Calcium, Chloride, Potassium, Sodium, Ammonium, Magnesium, Nitrate, Phosphate and/or dissolved oxygen for 4 independent reservoirs. An indoor farming module may include more or less reservoirs as required by the growing operation. Control over water conditions may be essential for optimal plant growth. A module may use a system of distributed control “pucks” for monitoring and control of the water conditions. This may allow monitoring and/or control to be completed wirelessly. Wireless monitoring and/or control may dramatically reducing upfront costs of manufacturing. Additionally, each puck may monitor and/or control a single reservoir, further increasing the robustness of the system by creating redundancy and ensuring that no single electronic failure results in crop loss.

Each puck may monitor the above-mentioned variables using a variety of commercial sensors. These values may then be integrated into proprietary control algorithms that control dosing pumps for each ion, ozone, UV, and an in line water chiller. An indoor farming module can incorporate all of these sensors and actuators, none of them, or a combination based on the required control for a given growing operation. Precise control over each ion is achieved using a salt mixture of each ion in an independent tank with a dosing pump or other dosing mechanism connected to each of the independent reservoirs. This may enable the grower to optimize the growing environment to a specific crop in real time using software changes only. As such, a grower can go from one crop to a different crop without any adjustment to the operating procedures or the fertilizer mixtures. This may be advantageous as a grower transitions crops within a farm and this, combined with individual control of irrigation to each level, may enable a grower to grower many different crops in a single module all under optimal conditions or to custom tailor the irrigation and fertilizer content to a specific stage of crop growth. Furthermore, this control over individual ions may allow the grower to adjust fertilizer mixtures precisely without dumping the hydroponic solution to rebalance the mixture. This may save additional costs and may improve crop yields.

The indoor farming module may include a drainage system that allows waste water to be consolidated into a single outlet. The environmental control system may be mounted in the ceiling. In additional examples, the environmental control system may be attached to one or more components of the module. In other examples, the environmental control system may be freestanding within the module. In examples, the environmental control system may capture and recycle any condensed water back to the recirculating system, thereby reducing the overall water usage.

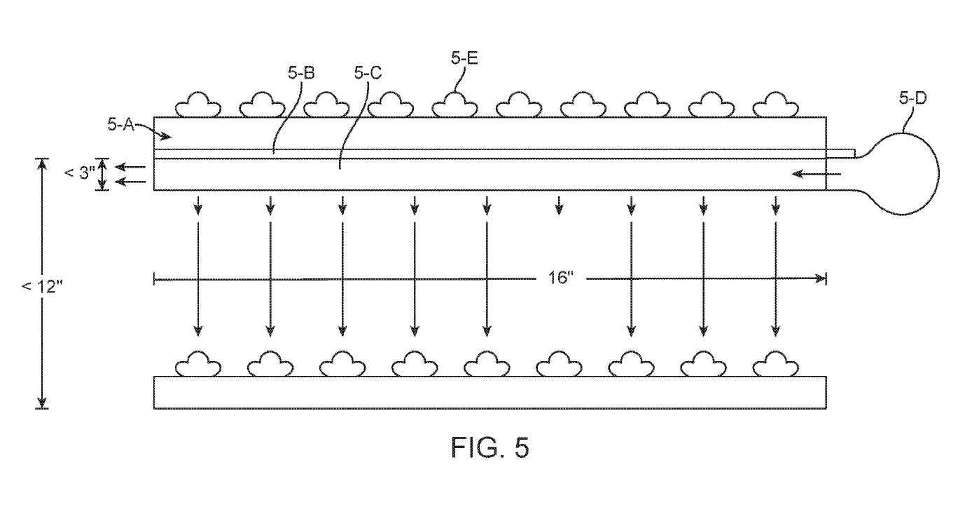

Additional examples of modular indoor farms are provided in FIGS. 5-7. In particular, FIG. 5 illustrates an integrated airflow management lighting system, in accordance with embodiments. In particular, FIG. 5 provides irrigation plumbing (“5-A”), a lighting system (“5-B”), transparent and/or reflective duct (“5-C”), an airflow generator (“5-D”), and crops (“5-E”). In examples, a transparent and/or reflective duct may have variable air vents. In examples, an integrated airflow management system may be used to ensure there is adequate air circulation throughout the plant canopy while enabling ultra-high density crop production.

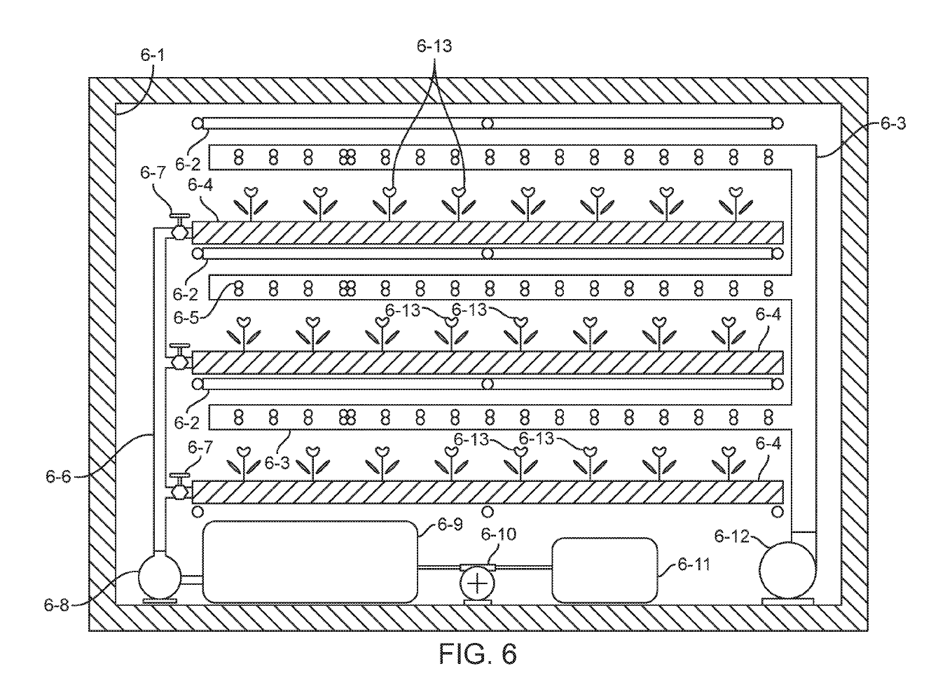

FIG. 6 illustrates a front, internal view of a modular indoor farm, in accordance with embodiments. In particular, FIG. 6 illustrates an insulated enclosure (“6-1”), low-profile lights (“6-2”), air-distribution plumbing (“6-3”), planting trays (“6-4”), air distribution orifices (“6-5”), water distribution plumbing (“6-6”), fill/drain valve (“6-7”), water pump (“6- 8”), water storage tank (“6-9”), additive metering pump (“6-10”), additive storage tank (“6- 11”), air blower (“6-12”), and plants (“6-13”).

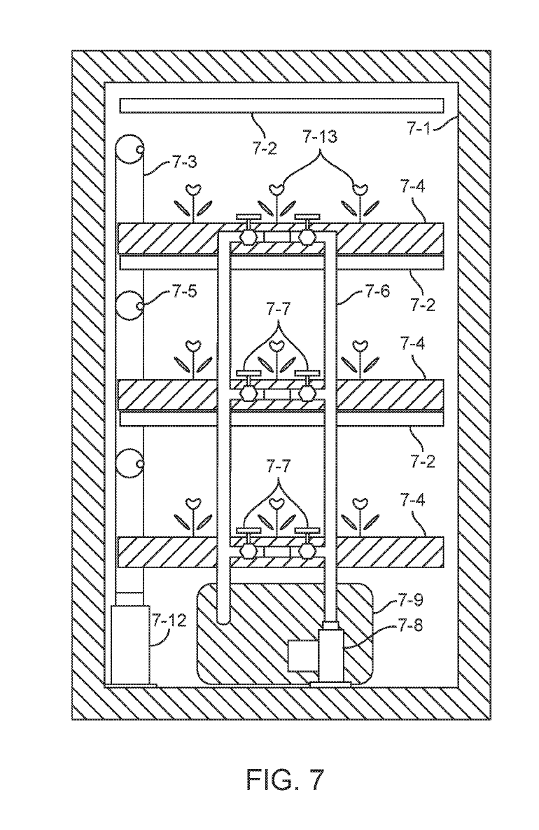

FIG. 7 illustrates a side, internal view of a modular indoor farm, in accordance with embodiments. In particular, FIG. 7 illustrates an insulated enclosure (“7-1”), low-profile lights (“7-2”), air-distribution plumbing (“7-3”), planting trays (“7-4”), air distribution orifices (“7-5”), water distribution plumbing (“7-6”), fill/drain valve (“7-7”), water pump (“7-8”), water storage tank (“7-9”), air blower (“7-12”), and plants (“7-13”).

An advantage of the module above existing indoor farms is the ability to produce at a significantly higher density as a result of more sophisticated monitoring and control, better water treatment practices, and the integrated air flow management lighting system. These additional features enable each level to be separated by less than 11″. This significant increase in crop production density may result in a more economically viable system of indoor crop production and may be a meaningful new step in indoor crop production.

### Horticultural Lighting Systems

Horticultural lighting systems, including integrated horticultural lighting systems, are provided herein. Horticultural lighting systems may be referred to as a “lighting system,” and may be meant for use in controlled environment agriculture (CEA) facilities. Horticultural lighting systems may include one or more of a heat sink, a plurality of printed circuit boards (PCBs), a plurality of light emitting diodes (LEDs) of different colors, a plurality of board mounted direct current (DC) to direct current (DC) transformers, a single alternating current (AC) to DC driver, and an integrated airflow system. An integrated airflow system may cool the light fixture and/or provide airflow to the crop canopy.

In order to optimize crop quality, plants benefit from exposure to airflow. However, sufficient airflow may be difficult to achieve in very compact growing conditions, such as high-density racking systems. As such, airflow systems may be provided to allow the plant canopy to receive significant airflow. In examples, vertical airflow from above the plant canopy may be preferable. In particular, vertical airflow may be used to provide plants with airflow in a targeted manner. Further, providing targeted airflow to a meristem of a plant may be beneficial in increasing plant growth. In some examples, an ideal airflow is 0.3 m/s directly at the meristem of the plant. In order to deliver optimal airflow at this speed to the plant canopy, the example embodiments are provided that are designed to incorporate an integrated airflow system that directs air from above directly at the meristem of the plants.

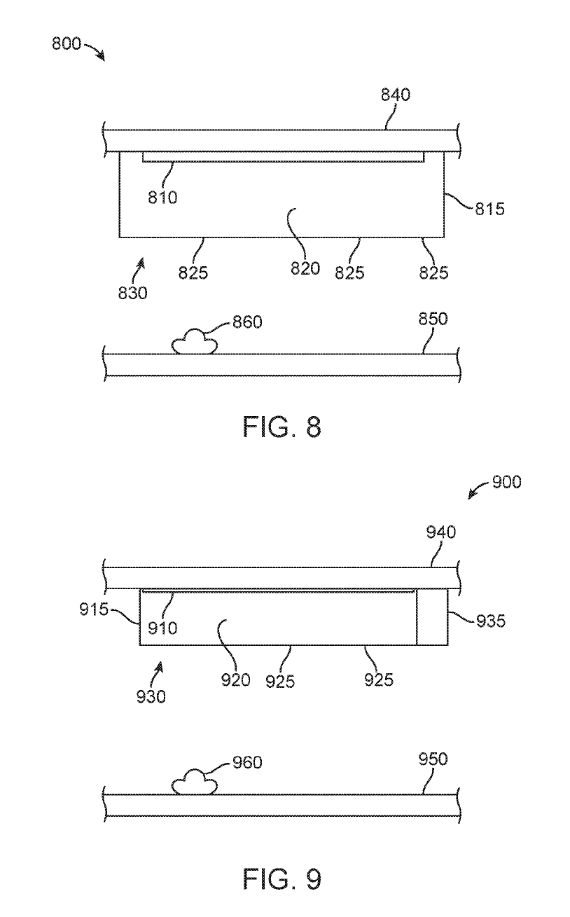

FIG. 8 illustrates an end view of a horticultural lighting system including an integrated airflow system, in accordance with embodiments. In particular, FIG. 8 illustrates a lighting system 800 having a light fixture 810, a reflective aluminum component 815, a duct 820, and a transparent plastic cover 830 having locations 825 of air holes (not shown). Additionally, lighting system 800 may be attached to an upper shelving component 840 in a high-density vertical racking system. The high-density vertical racking system may have an upper shelving component 840 and a lower shelving component 850. Additionally, the lower shelving component 850 may support a plant 860.

FIG. 9 illustrates a front view of an integrated horticultural lighting system having an integrated airflow system. In particular, FIG. 9 illustrates a lighting system 900 having a light fixture 910, a reflective aluminum duct cap 915, a duct 920, transparent plastic cover 930 having locations 925 of air holes (not shown), and a fan 935. As seen in FIG. 9, a duct fan on the far right pushes air through the duct, cooling the light fixture and providing airflow to the crop canopy below. Drawing is shown without the front reflective aluminum covering. Additionally, lighting system 900 may be attached to an upper shelving component 940 in a high-density vertical racking system. The high-density vertical racking system may have an upper shelving component 940 and a lower shelving component 950. Additionally, the lower shelving component 950 may support a plant 960.

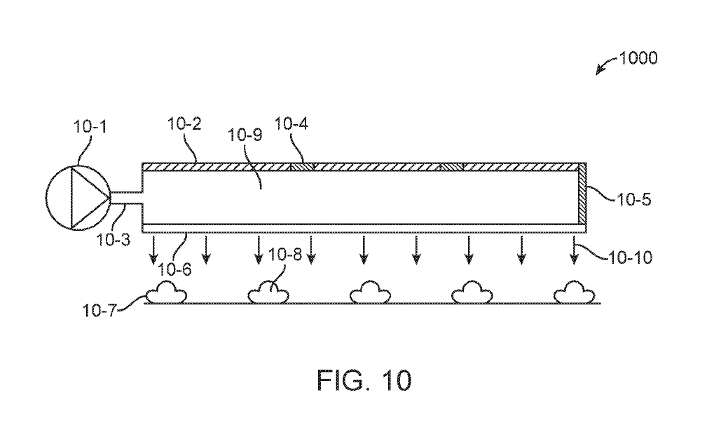

FIG. 10 illustrates a side view of a lighting system having a first airflow system, in accordance with embodiments. In particular, FIG. 10 illustrates an airflow generator (10-1) that provides airflow through an air flow pipe (10-3) into a lighting system 1000. The lighting system 1000 has a light fixture (10-2). Additionally, the lighting system 1000 has racking components (10-4). In particular, racking components (10-4) may be used to indicate locations where upper shelving connects to brackets that are secured against a wall of a controlled environment agriculture system. FIG. 10 also illustrates a component of the lighting system that may be composed of reflective aluminum (10-5).

While lighting fixture (10-2) may be located at a top portion of the lighting system 1000, a bottom cover (10-6) may be located at a bottom portion of the lighting system 1000. Additionally, a duct (10-9) may exist between the top portion and the bottom portion of lighting system 1000. As seen in FIG. 10, airflow (10-10) may pass from the lighting system through air holes (not shown) in bottom cover (10-6) so as to provide plants (10-7) with sufficient airflow. In particular, air holes (not shown) within the bottom cover of the lighting system 1000 may be placed to directly cover a meristem portion (10-8) of a plant (10-7). Directing airflow to a meristem of a plant may increase the growth rate of the plant multiple times.

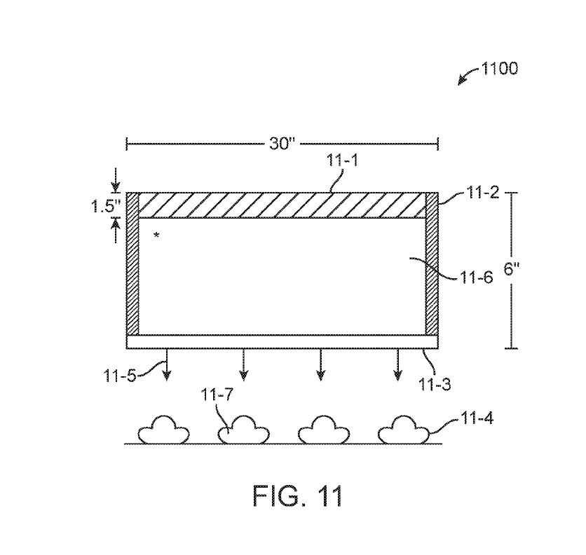

FIG. 11 illustrates an end view of a lighting system 1100 having a first airflow system, in accordance with embodiments. In particular, FIG. 11 illustrates that a length of a light fixture (11-1) may be approximately 30 inches. Further, the height of the light fixture as extending from an upper shelf (not shown) is merely 1.5 inches.

Additionally, FIG. 11 illustrates that reflective aluminum may be provided within the lighting system 1100. As seen in FIG. 11, a duct cavity (11-6) is formed in the lighting system 1100 through the light fixture (11-1), aluminum (11-2), and a bottom cover (11-3). The bottom cover (11-3) may be plexiglass. Additionally, bottom cover (11-3) may have air holes (not shown) to provide airflow to plants (11-4). In examples, the air holes may be aligned with a meristem (11-7) portion of the plant (11-4) so as to direct vertical airflow (11-5) to the plants. In comparison to FIG. 10, FIG. 11 has eliminated recitation of an airflow generator so as to discuss other portions of the FIG. 11 more clearly.

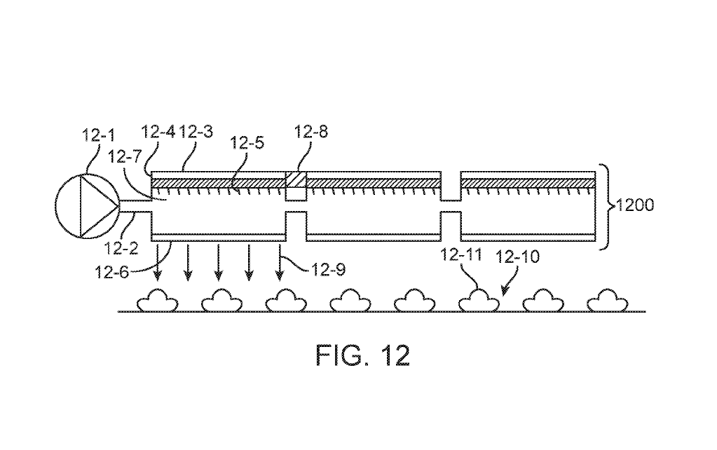

FIG. 12 illustrates a side view of a lighting system 1200 having a second airflow system, in accordance with embodiments. In particular, FIG. 12 illustrates an airflow generator (12-1) that provides airflow through an air flow pipe (12-2) into a lighting system 1200. The lighting system 1200 has an aluminum backing (12-3), a printed circuit board (12-4), and LED lights (12-5). Additionally, lighting system 1200 also comprises a bottom cover (12-6) having air holes. In examples, bottom cover (12-6) may be a lens. Additionally, lighting system 1200 also illustrates an inside of a light fixture and duct cavity of lighting system 1200. Also seen in FIG. 12 is an indication of racking areas (12-8), where the lighting system may attach to a bracket that is part of the vertical racking system. Further, FIG. 12 illustrates airflow (12-9) that is provided to plants (12-10). In examples, airflow (12-9) may be directed towards meristem (12-11) of plants (12-9).

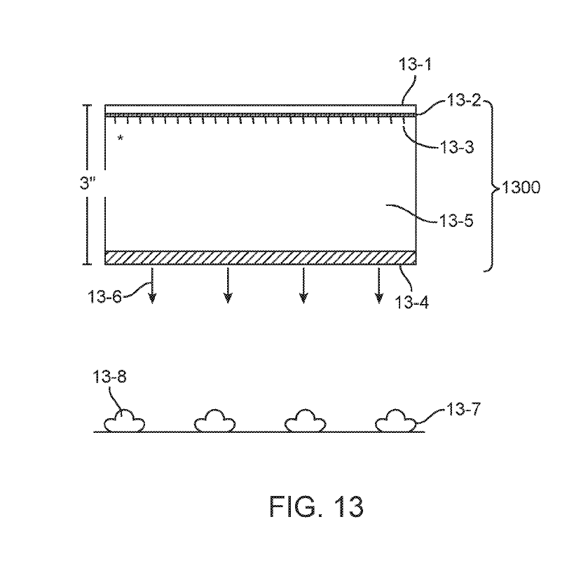

FIG. 13 illustrates an end view of a lighting system 1300 having a second airflow system, in accordance with embodiments. As seen in FIG. 13, a duct cavity (13-5) is within the lighting system 1300. FIG. 13 also illustrates aluminum backing (13-1), a printed circuit board (13-2), LEDs (3), a lens (13-4) with holes. In examples, lens (13-4) may be a bottom cover that may be made of plexiglass. In examples, the holes in lens (13-4) may be aligned with a meristem (13-8) portion of the plant (13-7) so as to direct vertical airflow (13-6) to the plants. In comparison to FIG. 12, FIG. 12 has eliminated recitation of an airflow generator so as to discuss other portions of the FIG. 13 more clearly.

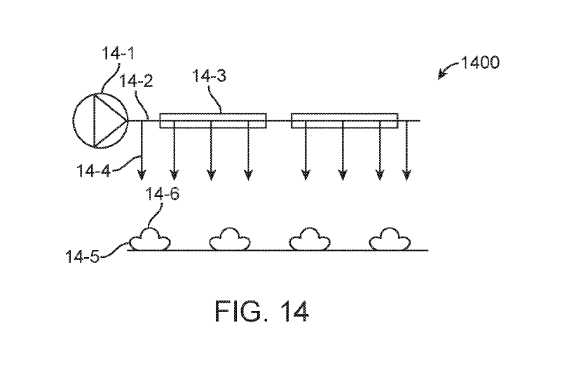

FIG. 14 illustrates a side view of a lighting system 1400 having a third airflow system, in accordance with embodiments. In particular, FIG. 14 illustrates a pressurized blower (14-1), air flow piping (14-2), and an LED fixture (14-3). This structure is used to provide airflow (14-4) to plants (14-5) within the high-density growing system. Additionally, airflow (14-4) may be provided to a meristem (14-6) of the plants (14-5)

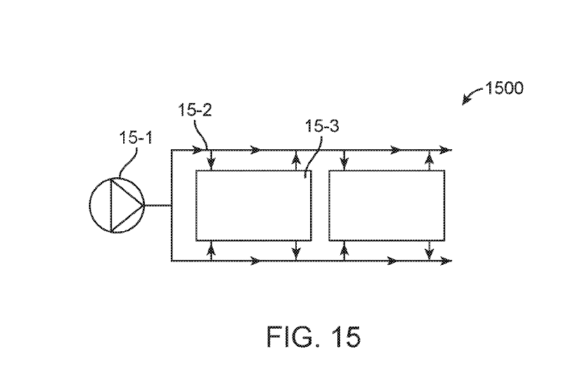

FIG. 15 illustrates a top view of a lighting system 1500 having a third airflow system, in accordance with embodiments. In particular, FIG. 15 illustrates airflow piping of air that is generated by the pressurized blower (15-1). As seen in FIG. 15, airflow piping (15-2) is provided around the LED fixtures (15-3).

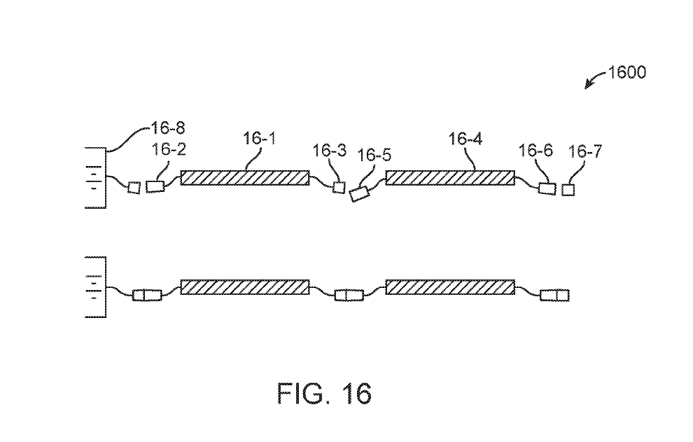

When installing lighting systems, it may be beneficial to install multiple lighting fixtures 1600 by daisy chaining the lighting fixtures to one another. FIG. 16 illustrates daisy chaining of lighting fixtures in accordance with embodiments. In particular, FIG. 16 provides a 250V DC Power Supply (16-8) that is connected to a male connector (16-2) of a first light fixture (16-1). The first light fixture (16-1) is additionally connected using a female connector (16-3) to a male connector (16-5) of a second light fixture (16-4). Additionally, a female connector of the second light fixture (16-4) is connected to a male cap (16-7).

In designing and constructing a vertical farm, maximizing production density and crop quality are the two primary considerations. In order to maximize production density, the number of levels within a given vertical space needs to be maximized. This can be accomplished by utilizing a light fixture with a very low profile and widely dispersed LEDs. Embodiments of lighting systems as disclosed may be 1.5″ thick to enable maximal production density. Furthermore, in some examples of lighting systems having LED lights, the LEDs are mounted on PCBs on the very back of the lighting fixture, thereby placing the LEDs further from the crop canopy. By having lighting components at the back of the lighting fixture, the LEDs may be exposed to more surface area of plants and/or crops, thereby increasing the potential for additional plant levels.

FIG. 17 illustrates a light fixture having diodes that are laid out in an interlocking formation 1700, in accordance with embodiments. As seen in FIG. 17, diodes that are green 1710, red 1720, and blue 1730 are each laid out in an E-shaped format. Additionally, the E-shaped formats interlock with each other. Use of the interlocking E-shaped format provides uniformity of light across the three colors provided. Additionally, the distributions of diodes across the light fixture allows for nearly uniform coverage.

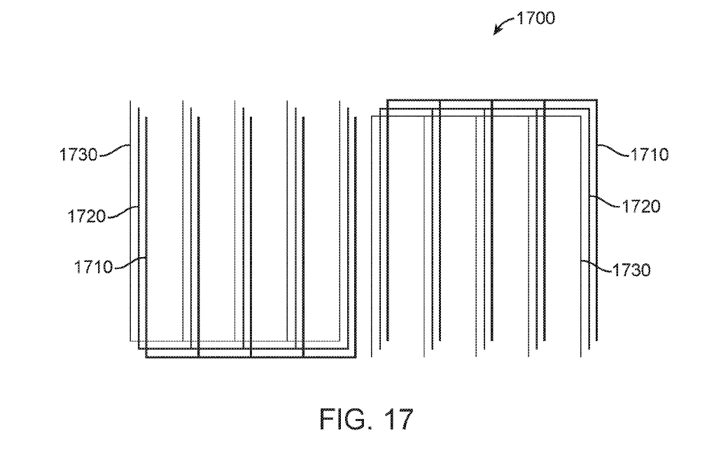

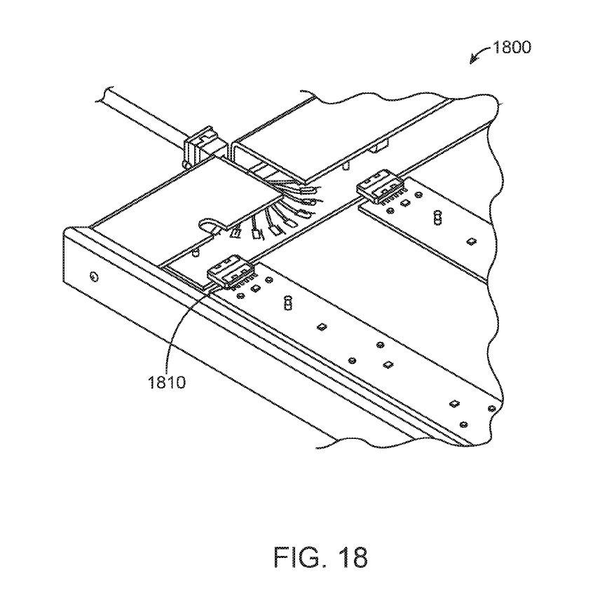

FIG. 18 illustrates inter-digitate hermaphroditic connectors 1810 in an integrated lighting system, in accordance with embodiments. In particular, a portion 1800 of a light fixture is provided.

FIG. 19 illustrates an overhead view of a diode layout row of an integrated lighting system, in accordance with embodiments. As seen in FIG. 19, the diode layout may include three distinct lines for placing LEDs. Each line, 1910, 1920, and 1930, may have a plurality of LED lights having a characteristic color. In particular, line 1910 may have LED lights of a red color, such as HyperRed; line 1920 may have LED lights of a blue color, such as Deep Blue; and line 1930 may have a LED lights of a green color, such as Mint White. The order of the colors may be modified; for instance, in one example, lines 1910, 1920, and 1930 may have LED lights of a red color, green color and blue color, respectively; in another example, lines 1910, 1920, and 1930 may have LED lights of a blue color, green color and red color, respectively; in a further example, lines 1910, 1920, and 1930 may have LED lights of a blue color, red color and green color, respectively. In an additional example, lines 1910, 1920, and 1930 may have LED lights of a green color, blue color and red color, respectively; and in another example, lines 1910, 1920, and 1930 may have LED lights of a green color, red color and blue color, respectively. In further examples, the colors within each line itself may vary. In particular, one or more of lines 1910, 1920, and 1930 may have multiple colors within the line selected from a group consisting of red, blue, and green.

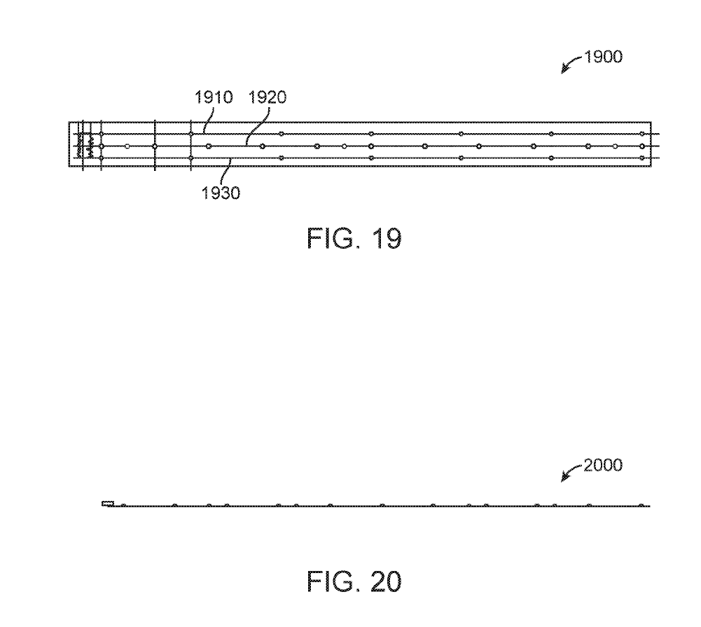

FIG. 20 illustrates a side view of a diode layout row of an integrated lighting system, in accordance with embodiments. As seen in FIG. 20, a diode layout row may be relatively thin. In particular, the height of the diode layout row may be less than 1 inch; less than 0.9 inches; less than 0.8 inches; less than 0.7 inches; less than 0.6 inches; less than 0.5 inches; less than 0.4 inches; less than 0.3 inches; less than 0.2 inches; or less than 0.1 inches. In additional examples, the height of the diode layout row may be more than 1 inch.

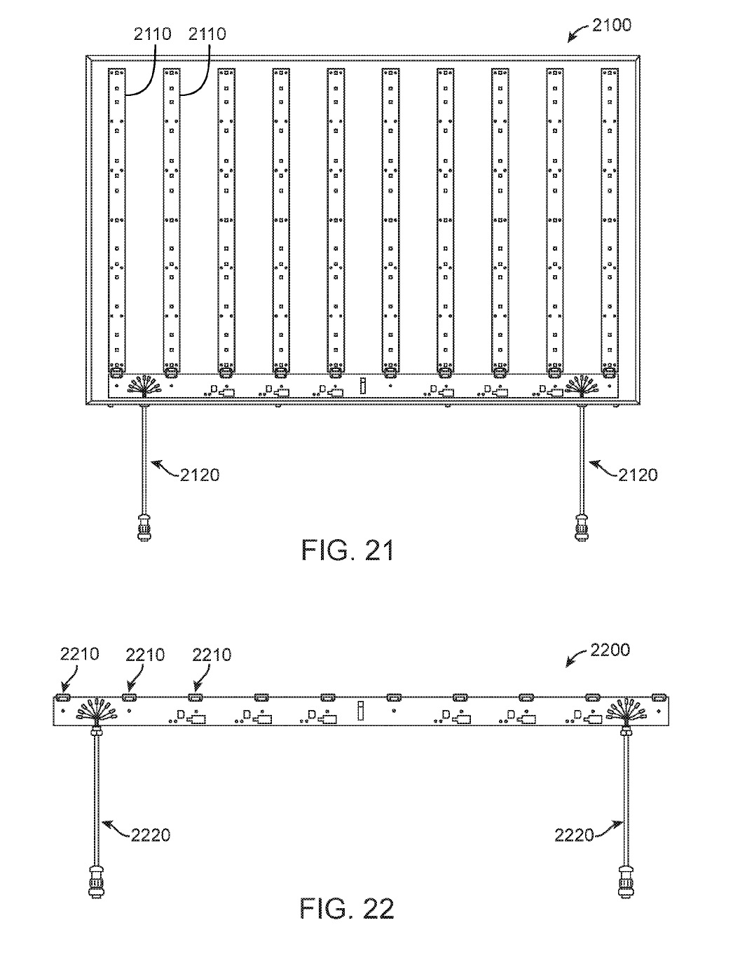

FIG. 21 illustrates on overview of a series of diode layout rows of an integrated lighting system, in accordance with embodiments. In particular, FIG. 21 illustrates a light fixture 2100 that has a 30 inch by 47.7 inch housing that is made from 1 mm aluminum. In examples, the LED boards may have a PCB spine which powers ten MCPCB LED boards 2110 with an evenly distributed array of each color wavelength. The spine board may have two 9 inch wire harnesses 2120 that may be used to carry power and/or signal in and out of each LED board.

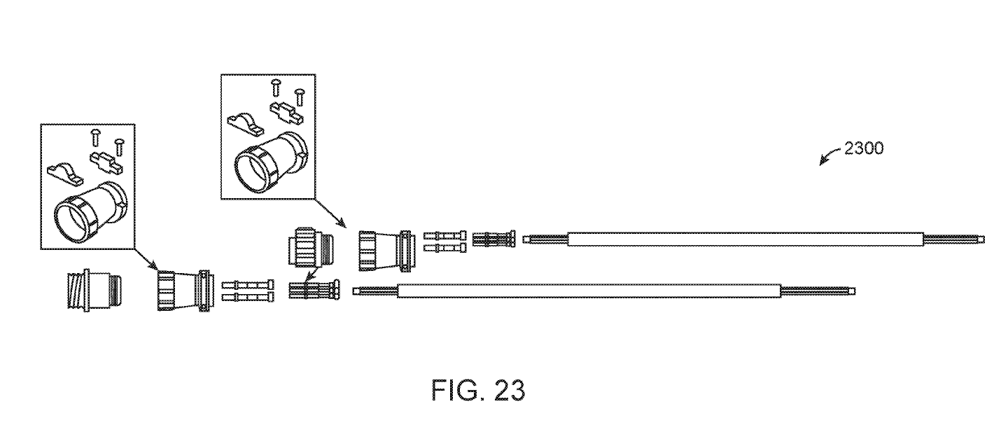

FIG. 22 illustrates a side view of a light fixture 2200 having ten LED boards 2210 and two wire harnesses 2220, in accordance with embodiments. Additionally, FIG. 23 illustrates a view of two wire harnesses, in accordance with embodiments. In particular, FIG. 23 illustrates a view of two wire harnesses 2300 that may be used with a light fixture such as light fixture 2100 and 2200 described above.

The heat sink is composed of a rolled aluminum sheet 1/32″ thick. Any conductor could serve this purpose, and the high heat transfer coefficient of aluminum in addition to its cost make it an excellent choice. Furthermore, the thinness of the heat sink allows the overall height of the fixture to be minimized. Additionally, the heat sink is designed to be large so as to maximize surface area. This can be further increased by creating bends in the heat sink but this is done at the cost of additional thickness in the fixture, which is undesirable.

The PCBs are standard finger boards, which reduce the cost of the fixture while also spreading the light in a uniform fashion across the entire fixture so as to optimize lighting efficiency across a level of any size. The PCBs could also be designed using a single board for the electrical control signals and several perpendicular boards for even distribution of the LEDs.

The LEDs are high powered red (660 nm), blue (450 nm) and mint white diodes chosen for their efficiency, although any LEDs could be appropriate choices. The PCBs are designed such that any standards 3 mm×3 mm LED can be used, making the fixture extremely customizable. Any color or brand of LEDs can be included in the fixture as required to optimize photosynthesis for a specific growing requirement.

The DC-to-DC transformers are board mounted and utilize a Bucking Circuit to convert a high voltage DC power source to the appropriate low voltage DC source for each string of LEDs. The transformer-Bucking Circuit combination is further selected for optimal efficiency. There is an independent transformer for each color such that the intensity of each color can be adjusted individually and the yield photon flux (YPF) can be optimized for any crop and at any time throughout the crop's lifecycle by simply changing a control signal in the appropriate software. This adjustment is done using a Pulse-Width Modulation (PWM) signal delivered by an external device.

The AC-to-DC driver takes a high voltage AC source and converts it into a high voltage DC source. The AC voltage can be any voltage ranging from 120V AC to 480V AC. The driver can convert this AC voltage to any DC voltage ranging from 12V DC to 250V DC. The described system operates on 250V DC. The AC-to-DC driver used can deliver 8 separate and parallel 250V DC sources. Each 250V DC source can power 18 light fixtures. This allows 9 fixtures to be electrically coupled (“daisy chained”). Daisy chaining multiple fixtures dramatically decreases install costs, which can often be as much as the cost of the light fixture itself. Therefore, daisy chaining can reduce the fully burdened cost of the lighting system by half.

The integrated airflow system can be implemented in a variety of ways. The first possible way consists of two highly reflective aluminum sides and a transparent plastic bottom that collectively form a duct with the light fixture at the top. Holes are drilled in the plastic bottom of the duct to allow air to escape. The holes have a 1″ diameter and are drilled at 6″ intervals, although other sizes and spacing would be appropriate based upon the desired airflow volume and type (turbulent or laminar) and the spacing of the plants within the system. One end of this duct is closed with another reflective piece of aluminum and the other end is coupled to a high powered duct fan. The duct fan pushes air over the light fixture and through the holes, eventually providing air flow for the plants while also cooling the fixture. This cooling causes the junction temperature of the LEDs to decrease, thereby improving the efficiency of the fixture. Any other method of generating airflow would also be appropriate, for example a regenerative blower, an air compressor, a ring compressor, or similar. The second way to implement the integrated airflow system is to increase the overall width of the light fixture to 3″ or more and include a clear plastic lens with holes drilled throughout. In this way, the light fixture itself effectively becomes the duct. This reduces overall materials cost, labor, installation, and complexity while still accomplishing both goals of cooling the LEDs and providing effective airflow for the crop. Finally, the integrated airflow can be accomplished using a standard <=1.5″ deep light fixture with a standard lens (no holes) and running pipes, in this case 1.5″ PVC pipes, along each side of the light fixture. These pipes can have holes drilled in them to provide airflow directly to the plant canopy and these pipes can also be routed into the light fixture such that each fixture has one insertion on one end and another insertion on the other end. In this way the light fixture can remain watertight while also be actively cooled and the entire system can also provide optimal airflow to the plant canopy.

### Sensor Modules

Sensor modules that may be used in CEAs are provided herein. Sensor modules as provided herein may comprise one or more of low profile housing, a plurality of sensors, and/or a plurality of linear actuators with the motors and power supplies so as to power the sensors.

In order to optimize production density, plant levels in a vertical farm are placed as closely together as possible. This means that there is minimal room, <12″, in between plant levels and often <4″ between the plant canopy and the light fixture above it. Therefore, in order to implement any sensor module that can record plant specific data from above the plant canopy, the sensor module must necessarily be very low profile (<3″). The subject invention is based upon board mounted cameras and sensors coupled to custom printed circuit boards (PCBs) in a housing that is designed to be low profile.

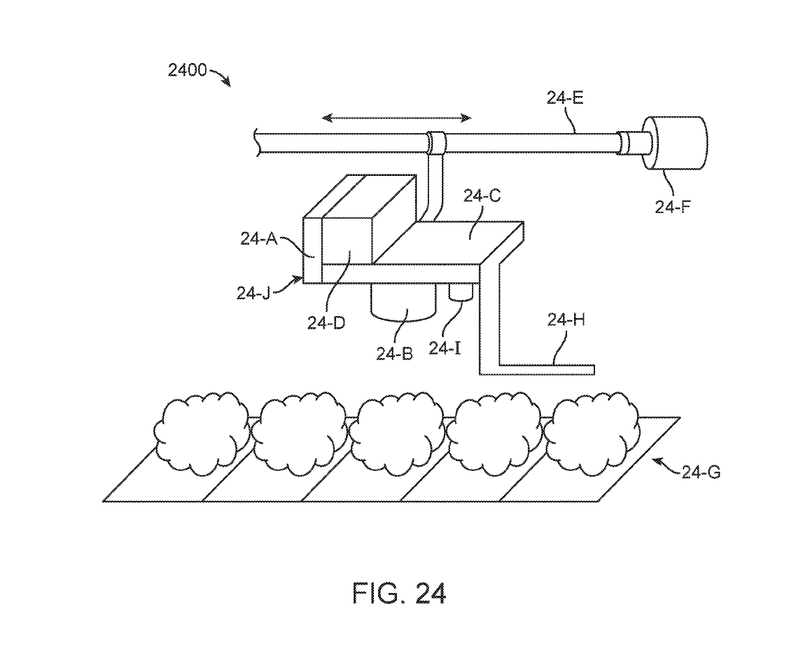

The sensors incorporated can include a video camera, DSL camera, spectrum specific (IR, near IR, UV, etc.) camera, temperature, CO2 sensor, O2 sensor, O3 sensor, relative humidity, air speed, tissue temperature sensor, ultrasound, and radiation. Other sensors could also be coupled to the housing in a similar manner. FIG. 24 illustrates a perspective view 2400 of a sensor module, in accordance with embodiments. In particular, FIG. 24 illustrates a sensor casing 24-A that includes one or more of temperature, CO2, and relative humidity sensors. Additionally, FIG. 24 also illustrates a camera 24-B. In examples, camera 24B may include custom internal filters for visual- and/or spectrum-specific imaging. FIG. 24 also illustrates a wifi-enabled chip 24-C and a battery 24-D. In examples, battery 24-D may be a lithium-ion battery. FIG. 24 further illustrates an actuator 24-E in a first stage, an electric motor 24-F, a single row of crops 24-G as shown for illustrative purposes; a PAR sensor 24-H, an IR temperature sensor 24-I, and a USB port 24-J. In examples, IR temperature sensor 24-I may be used for measuring tissue temperature. Additionally, in some examples, USB port 24-J may be used for docking with a charging dock.

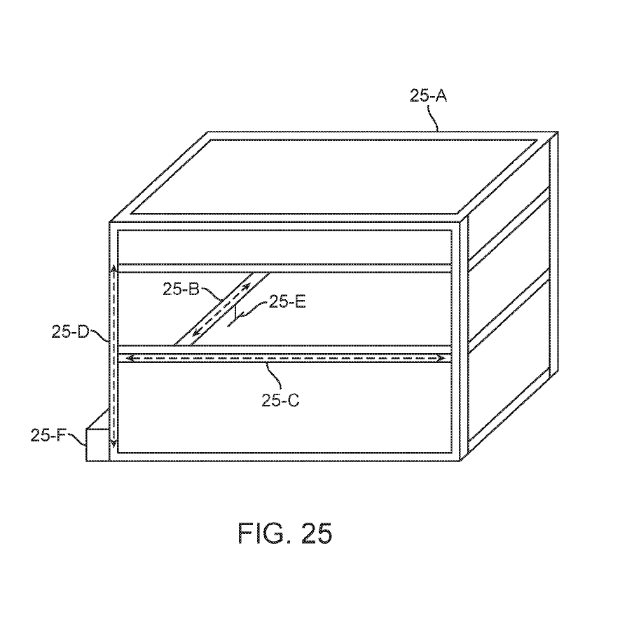

Additionally, FIG. 25 illustrates a perspective view 2500 of a sensor module within a single growing unit, in accordance with embodiments. FIG. 25 illustrates a growing unit frame 25-A, a linear actuator 25-B in a first stage, a linear actuator 25-C in a second stage as coupled to the first stage with a rotary actuator that allows the first stage to be a rotary actuator, a linear actuator 25-D in a third stage, a sensor housing 25-E, and a charging component 25-F. As seen in FIG. 25, linear actuator 25-B may move between a front and back portion of the growing unit; linear actuator 25-C may move between a left and right portion of the growing unit; and linear actuator 25-D may move between an upper and lower portion of the growing unit.

The subject invention includes at least 2 board mounted cameras. By using board mounted cameras, the sensor module can be very low profile. By having 2 or more cameras, the module can provide multiple perspectives to a computer vision algorithm enabling more robust calculation of canopy characteristics. The addition of an ultrasound distance sensor further increases the accuracy of canopy height, leaf area index, and other calculations. By using a plurality of sensors, the accuracy required from each individual sensor is dramatically reduced, enabling the entire sensor module to be constructed for a fraction of the cost of a single more expensive sensor. This is particularly the case with the cameras used because machine vision cameras can be $10 k or more. If wavelength specific data is required, an inexpensive camera with a filter can be used to reduce costs. Several of these cameras can be mounted together, each with a unique filter, to provide wavelength specific images in any required wavelength bands. The subject invention uses filters in the 640-680 nm, 680-720 nm, and 720-740 nm bands but filters for any other band could also be used as needed. The combination of visual imaging, wavelength specific imaging, ultrasound distance data, CO2, temperature, humidity, and air speed in particular give a very comprehensive description of the most important aspects of the plant environment and this data can be used to optimize that environment for any desired output variable such as yield, flavor, color, etc. In addition, this data can be used to diagnose the plant for disease, nutrient deficiency, or slow or abnormal development. By diagnosing plants early, crop losses can be avoided and crop outcomes can be dramatically improved.

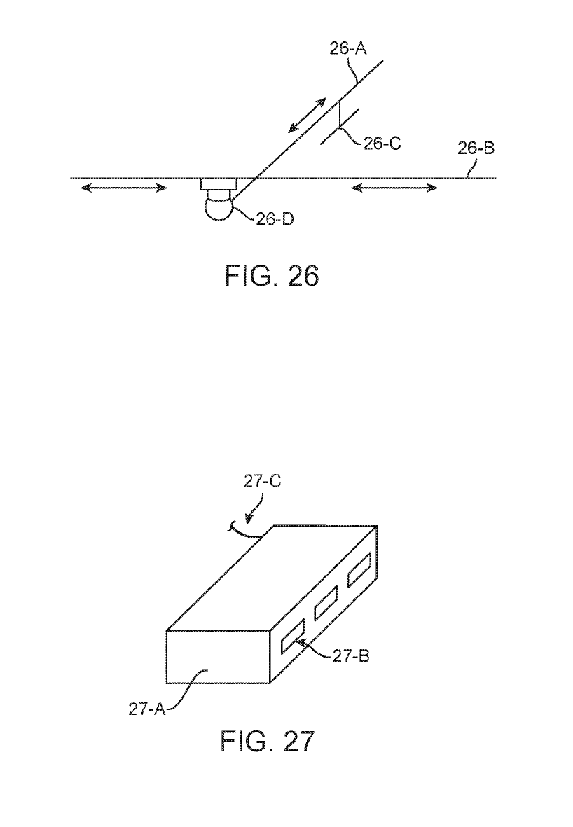

The sensor module includes a linear actuator coupled to the housing. The linear actuator is mounted above the crop canopy and moves the housing from side to side over a row of plants enabling the sensors to collect data individually on each plant. The housing could also be stationary in any number of positions. A stationary module could achieve the same goal of plant specific monitoring if the plants were themselves moving beneath the module. In addition, monitoring a single plant or single set of plants could be used as a model for the entire crop and decisions could be made in the same fashion for the entire crop based on the data acquired from the stationary sensor module. The sensor module also includes a second linear actuator attached to the first, which moves the first linear actuator and the housing by way of it being coupled to the first linear actuator across multiple rows of crops. The sensor module includes a third linear actuator coupled to the second linear actuator, which moves the housing up and down across all the crop levels within the farm. The sensor module also includes a single rotary actuator that swivels the first actuator 90 degrees making it parallel with the second linear actuator and making it possible to raise and lower the module across levels. In this way, a single sensor module is able to collect all the desired data from each plant in a consistent manner multiple times per day. A number of other actuator combinations could be used to move the sensor module across the plant canopy including pneumatic, hydraulic, linear, rotary actuators, lead screws, etc. FIG. 26 illustrates a perspective view of a rotary actuator attached to a sensor housing, in accordance with embodiments. In particular, FIG. 26 illustrates a rotary actuator 26-A that is a linear actuator in a first stage; a linear actuator 26-B in a second stage, a sensor housing 26-C, and a rotary actuator 24-D that is coupling the first stage of the linear actuator to the second stage of the linear actuator.

By moving the sensor module across the plant canopy, an unprecedented amount of data can be collected without the need for thousands of expensive sensors. The sensor module may further comprise a plurality of electrical motors capable of accomplishing the required actuation to move the housing across the plant canopy.

The sensor module may further comprise a lithium-ion battery capable of powering the camera, sensors, and the motor that moves the sensor module along the first linear actuator. In addition, the module comprises a lithium-ion battery for powering the second linear actuator, and a third lithium-ion battery for powering the third linear actuator. Each battery is charged independently at the docking station. It is not necessary to have three separate batteries nor is it necessary that they are each charged independently at the docking station. Many other battery combinations could be used to power the unit. Alternatively the unit could be wired directly to an electrical power supply.

The sensor module may further comprise a docking station wherein the local power supply on the housing, which powers the sensors and the motors, is plugged in automatically and charged. FIG. 27 illustrates a charging dock 27-A in accordance with embodiments. The docking station includes a 120V cable 27C as well as three standard 9-pin USB port 27-B that deliver a 5V continuous charge to each battery of the sensor module. Many other ports and voltages could be used. In this way, all the batteries on the module are charged in less than one hour. The sensor module returns to the dock after each full circuit of monitoring, or approximately three times per day.

The sensor module may further comprise a wifi enabled chip, which transmits the data from the sensors to a central router elsewhere in the farm. This could also be done using any number of other wifi or Bluetooth devices or any wireless or wired technology for data transmission. The sensors are wired directly into the chip as is the motor on the first linear actuator. The other two motors are wired into their own chips, all of which communicate via the wifi.

### Control Systems

The module may include a control system for controlling intake and/or exhaust fans. The control of intake and/or exhaust fans may be used to modulate the uptake of external air. Introducing external air may be used as an effective way to cool the module in cold weather climates, thereby reducing cooling costs and/or improving overall efficiency. External air can also include high levels of CO₂, which can be introduced to reduce supplemental CO₂ usage further reducing costs.

Actuators within the system may be controlled via any number of control methodologies including 0-10V outputs, 0-5 A outputs, 2-20 A outputs, Bluetooth, wifi, other analog current, other analog voltage, and/or other digital protocols, etc. The module may include systems for collecting ambient data, water quality data, and plant specific data such as photographs, videos, color, texture, and/or weight, etc. Additionally, the module may include systems for transmitting all of data to the internet where it can be stored, aggregated, analyzed, and compared with output measurements. The module can also be expanded to include instrumentation for the measurement of a plurality of additional variables in the ambient environment, in the water, from each individual plant, from entire levels, from entire crops, and/or any combination of the above.

Control systems for monitoring and/or regulating CEAs are provided. In examples, control systems may be used to implement a method for communicating with the internet, a process logic computer (PLC), a plurality of sensors, and a plurality of actuators. The control system communicates with the internet via a Cisco integrated services router (ISR) that includes 4G/LTE functionality, and Ethernet as a triple redundancy. Any other similar routing device could be used to communicate with the internet and depending on the number of sensors and actuators, additional switches may be required to incorporate all of the required components. Any standard Ethernet switch is appropriate. The PLC is a Rockwell/Alan Bradley Compact Logix with expandable input/output (I/O) modules. This PLC allows the user to specify how many sensors and of what type are required and how many actuators and of what type are required and subsequently choose the appropriate number of expansion I/O modules of both analog and digital type to support the desired instrumentation. Further, the PLC provides robust on-site execution of all processes, further insulating the system from failure as a result of a loss of connectivity. Any other PLC with expandable I/O modules is also appropriate. Further, there is no absolute requirement for a true physical PLC. The logic functions can be pushed both closer to the instrumentation by incorporating smart logic chips onto individual sensors and actuators. The logic functions of the PLC can also be moved to the cloud and all computing can be done in the internet. There are advantages and disadvantages to all three of these designs, and the final decision to use a physical PLC was made due to a strong preference for robust reliability in the process. The I/O modules are currently current input and current output modules (0-5 mA and 4-20 mA) and voltage input and voltage output modules (0-10V), as these are industry standard communication protocols, but any other electrical, mechanical, acoustic or other signal would also be appropriate, including wi-fi, Bluetooth, Ethernet IP, HART, Modbus TCP, etc. Many of these are great options; a wi-fi enabled Arduino chip is often the most cost effective option for communicating between PLC and instrumentation, however it is a less robust and secure protocol. The control system includes a vast assortment of sensors that are customized according to the grower's needs; these include, but are not limited to water sensors for, pH, electrical conductivity (EC), dissolved oxygen (DO), chlorine, temperature, turbidity, and flowrate, ambient sensors for temperature, CO2, relative humidity, airflow, light levels, spectrum specific light levels, photos, videos, occupancy sensors, and weight or strain gauges. These sensors interface with the PLC through a variety of communication protocols as previously mentioned. The data from these sensors is processed by a sophisticated machine learning algorithm that enables smart control of the actuators thereby optimizing all environmental conditions. The control system includes the following actuators, dosing pumps for fertilizer addition and pH balancing, valves and pumps to control source water and water flow, an ozone system to control DO levels and to remove any unwanted pathogens, HVAC units to control temperature and humidity, CO2 regulators to control CO2 levels, dimmers on all lights to control both overall light level as well as intensity of each individual color (450 nm, 660 nm, 520 nm, etc.), and several others. These actuators are only a sampling of the possible configurations, and hundreds of different actuators could be added to the system.

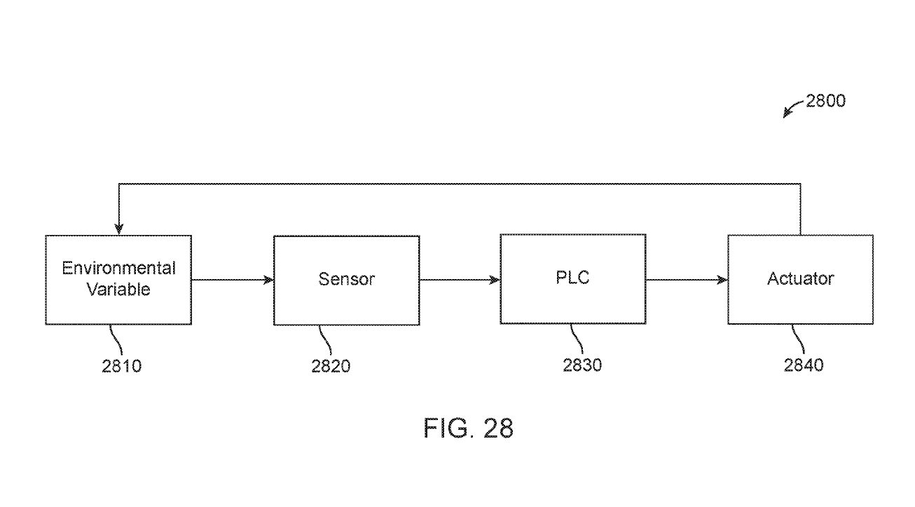

FIG. 28 illustrates an overview of a control system architecture 2800, in accordance with embodiments. In particular, as seen in FIG. 28, environmental variables 2810 may be monitored by a sensor 2820. The sensor may send data to the PLC 2830, which in turn may adjust an actuator 2840. The actuator 2840, in turn, may affect the original environmental variable 2810, thereby forming a feedback loop.

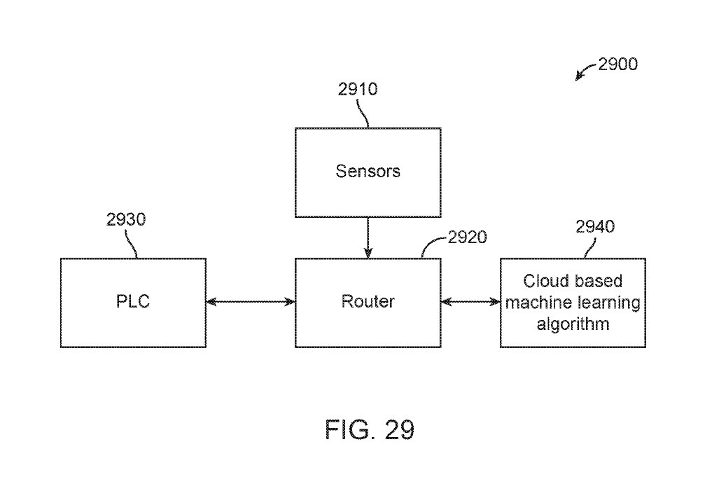

FIG. 29 illustrates a process 2900 of data transfer, in accordance with embodiments. In particular, as seen in FIG. 29, data may be transferred to a cloud via a router 2920. In examples, data may be relayed from sensors 2910 to the PLC 2930. In other examples, data can be relayed directly from sensors 2910 to router 2920. Additionally, router 2920 may communicate with a cloud-based server, such as cloud-based machine learning algorithm component 2940. When router 2920 communicates with a cloud-based server, the router may deposit data and/or receive updates to a process of control logic.

### Computer Control Systems

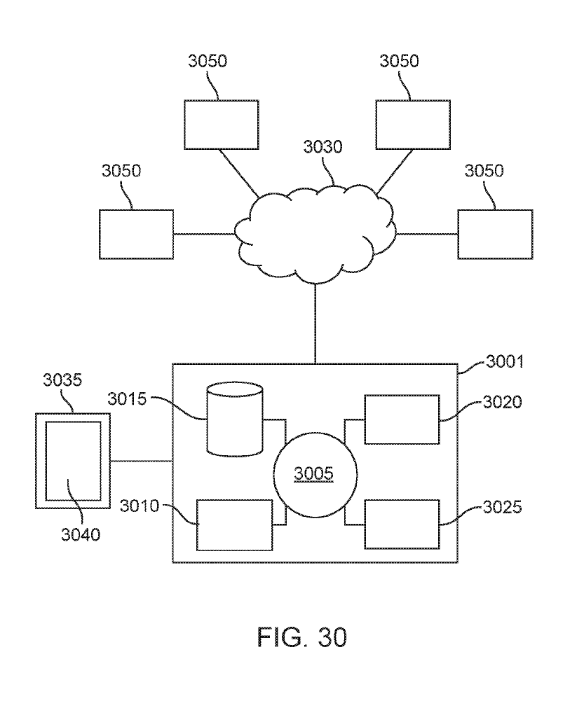

The present disclosure provides computer control systems that are programmed to implement methods of the disclosure. FIG. 30 shows a computer system 3001 that is programmed or otherwise configured to monitor and/or regulate CEA's. As seen in FIG. 30, CEA's 3050 are connected to computer system 3001 through network 3030. The computer system 3001 can regulate various aspects of monitoring and regulating CEA's, such as indoor farm modules, of the present disclosure, such as, for example, determining whether portions of a given crop are too warm and automatically cooling the crops accordingly. Another aspect includes monitoring leaf growth using ultrasound and using the information to determine how to feed and/or treat the plants and/or crops based on their current growth cycle. The computer system 3001 can be an electronic device of a user or a computer system that is remotely located with respect to the electronic device. The electronic device can be a mobile electronic device.

The computer system 3001 includes a central processing unit (CPU, also “processor” and “computer processor” herein) 3005, which can be a single core or multi core processor, or a plurality of processors for parallel processing. The computer system 3001 also includes memory or memory location 3010 (e.g., random-access memory, read-only memory, flash memory), electronic storage unit 3015 (e.g., hard disk), communication interface 3020 (e.g., network adapter) for communicating with one or more other systems, and peripheral devices 3025, such as cache, other memory, data storage and/or electronic display adapters. The memory 3010, storage unit 3015, interface 3020 and peripheral devices 3025 are in communication with the CPU 3005 through a communication bus (solid lines), such as a motherboard. The storage unit 3015 can be a data storage unit (or data repository) for storing data. The computer system 3001 can be operatively coupled to a computer network (“network”) 3030 with the aid of the communication interface 3020. The network 3030 can be the Internet, an internet and/or extranet, or an intranet and/or extranet that is in communication with the Internet. The network 3030 in some cases is a telecommunication and/or data network. The network 3030 can include one or more computer servers, which can enable distributed computing, such as cloud computing. The network 3030, in some cases with the aid of the computer system 3001, can implement a peer-to-peer network, which may enable devices coupled to the computer system 3001 to behave as a client or a server.

The CPU 3005 can execute a sequence of machine-readable instructions, which can be embodied in a program or software. The instructions may be stored in a memory location, such as the memory 3010. The instructions can be directed to the CPU 3005, which can subsequently program or otherwise configure the CPU 3005 to implement methods of the present disclosure. Examples of operations performed by the CPU 3005 can include fetch, decode, execute, and writeback.

The CPU 3005 can be part of a circuit, such as an integrated circuit. One or more other components of the system 3001 can be included in the circuit. In some cases, the circuit is an application specific integrated circuit (ASIC).

The storage unit 3015 can store files, such as drivers, libraries and saved programs. The storage unit 3015 can store user data, e.g., user preferences and user programs. The computer system 3001 in some cases can include one or more additional data storage units that are external to the computer system 3001, such as located on a remote server that is in communication with the computer system 3001 through an intranet or the Internet.

The computer system 3001 can communicate with one or more remote computer systems through the network 3030. For instance, the computer system 3001 can communicate with a remote computer system of a controlled environment agriculture system. As seen in FIG. 30, four controlled environment agriculture systems 3050 are provided. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 3001 via the network 3030.

Methods as described herein can be implemented by way of machine (e.g., computer processor) executable code stored on an electronic storage location of the computer system 3001, such as, for example, on the memory 3010 or electronic storage unit 3015. The machine executable or machine readable code can be provided in the form of software. During use, the code can be executed by the processor 3005. In some cases, the code can be retrieved from the storage unit 3015 and stored on the memory 3010 for ready access by the processor 3005. In some situations, the electronic storage unit 3015 can be precluded, and machine-executable instructions are stored on memory 3010.

The code can be pre-compiled and configured for use with a machine have a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 3001, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 3001 can include or be in communication with an electronic display 3035 that comprises a user interface (UI) 3040 for providing, for example, the ability to monitor and/or regulate multiple CEA systems at the same time and/or from one user interface. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 3005. The algorithm can, for example, monitor growth of a given plant in a horticultural high-density growing system; receiving an indication of the progress of growth (e.g., size of plant, leaf density, etc.); associate the growth characteristic with a stage of growth of the given plant; and modify growing conditions of the given plant based on the determined stage of growth of the given plant.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1.-23. (canceled)

24. A high-density horticultural system, the horticultural system comprising:
a first shelving component that is attached to a first bracket within a vertical racking system, the first shelving component extending horizontally from the first bracket;
a second shelving component, wherein the second shelving component is attached to a bracket within the vertical racking system, the second shelving component extending vertically from the second bracket, wherein the second bracket is vertically displaced 11 inches from the first bracket;
at least one sensor module that is placed within the 11 inches of vertical displacement between the first bracket and the second bracket; and
a lighting system that extends down from either the lower shelving component and/or the upper shelving component, wherein the lighting system comprises at least one light emitting diode of white, green red, blue, or any combination thereof.

25. The high-density horticultural system of claim 24, wherein the sensor module is translatable in at least one direction with respect to the vertical racking system.

26. A high-density horticultural system of claim 24, wherein the bottom cover has a plurality of holes that are configured to direct airflow to plants beneath the lighting system.

27. A high-density horticultural system of claim 26, wherein the air flow passages provide airflow to plants beneath the lighting system at a rate of about 0.5 m/s.

28. A high-density horticultural system of claim 24, wherein the lighting system in the racking system is adjacent to at least one airflow passage attached to the racking system so as to provide airflow to plants between the lighting system.

29. The horticultural high-density growing system of claim 24, wherein the first bracket is attached to a wall of an indoor farm module.

30. The horticultural high-density growing system of claim 24, wherein the second bracket is attached to a wall of an indoor farm module.

31. The horticultural high-density growing system of claim 24, wherein the first bracket and the second bracket are attached to the same wall.

32. The horticultural high-density growing system of claim 24, wherein at least one of the first bracket and the second bracket are not mounted to a wall.

33. The horticultural high-density growing system of claim 24, wherein the first shelving component is vertically displaced at most 11 inches from the second shelving component.

34. The horticultural high-density growing system of claim 24, wherein the first shelving component is vertically displaced at most 10 inches from the second shelving component.

35. The horticultural high-density growing system of claim 24, wherein the first shelving component is vertically displaced at most 8 inches from the second shelving component.

36. The horticultural high-density growing system of claim 24, wherein the first shelving component is vertically displaced at most 6 inches from the second shelving component.

37. The horticultural high-density growing system of claim 24, wherein the first shelving component is vertically displaced at most 4 inches from the second shelving component.

38. The horticultural high-density growing system of claim 24, wherein a top side of either the first shelving component or second shelving component supports a plant.

39. The horticultural high-density growing system of claim 24, wherein the sensor module includes an ultrasound sensor.

40. The horticultural high-density growing system of claim 24, wherein the horticultural high-density growing system is within a controlled environment agriculture system.

41. The horticultural high-density growing system of claim 24, wherein the horticultural high-density growing system is within an indoor farm module.

42. The horticultural high-density growing system of claim 24, wherein the system comprises a number of shelving components selected from the group consisting of three, four, five, six, seven, eight, nine, and ten.

43. A method for regulating a horticultural high-density growing system, comprising:
monitoring growth of a given plant in the horticultural high-density growing system;
receiving an indication of leaf density within the high-density growing system;
associating the received leaf density with a stage of growth of the given plant; and
modifying growing conditions of the given plant based on the stage of growth of the given plant.
